(19) United States
(12) Patent Application Publication
(10) Pub. No.: US 2015/0044986 A1
(43) Pub. Date: Feb. 12, 2015

(54) NOTATION-ENABLED COMMUNICATION SYSTEM AND METHOD OF USE THEREOF

(71) Applicant: Estech Systems, Inc., Plano, TX (US)

(72) Inventors: Eric Suder, Plano, TX (US); Doug Boyd, Plano, TX (US); Harvey Wende, Plano, TX (US); George Platt, Plano, TX (US); Brian Berger, Plano, TX (US)

(73) Assignee: Estech Systems, Inc., Plano, TX (US)

(21) Appl. No.: 13/940,372

(22) Filed: Aug. 9, 2013

(51) Int. Cl. H04M 15/00

(52) U.S. Cl. CPC H04M 15/44; H04M 15/43
USPC 455/406

(57) ABSTRACT

An notation-enabled communication system and method of generating billing data for a customer. One embodiment of a notation-enabled communication device includes: (1) a communication subsystem operable to transmit and receive communication data associated with a call, and (2) a call logger configured to accept notations associated with the call, generate a call detail record (CDR) based on the call and the notations and submit the CDR to a database.

### TECHNICAL FIELD

This application is directed, in general, to generation of customer billing data and, more specifically, to communication devices, methods and systems configured to record call details and call notations that can be used for generating customer billing data.

### BACKGROUND

Timekeeping is an essential part of many businesses, particularly those in industries that rely on the concept of billable time, such as the legal industry. Inaccurate or incomplete timekeeping can cost businesses time and thus money. Professionals have long struggled to capture every transaction between them and their customers. As technology improves and proliferates throughout a business, the quantity of these transactions increases significantly and, consequently, the ability of professionals to track time spent is further stressed. Many professionals carry out multiple conversations with multiple customers and are bombarded with overwhelming amounts of email, telephone calls and text messages. As correspondence becomes a larger portion of professionals' day, filling the gaps in their timekeeping becomes more critical.

A variety of products and services are available to businesses to help recapture this lost time. Businesses can use specialized software to simplify time entry and tracking. Many of these software tools pair well with accounting and invoicing software. Others may be fully integrated with accounting and invoicing. The software can be expanded to install on mobile computing devices for mobile access to timekeeping tools. Other solutions include tracking tools that capture time spent on a telephone call, on an email, or any other transaction. Certain tools can even monitor web and application usage. These time tracking tools allow businesses to accurately compile time spent on a given customer to maximize billable time.

### SUMMARY

One aspect provides a notation-enabled communication device. In one embodiment, the device includes: (1) a communication subsystem operable to transmit and receive communication data associated with a call, and (2) a call logger configured to accept notations associated with the call, generate a call detail record (CDR) based on the call and the notations and submit the CDR to a database.

Another aspect provides a method of generating billing data for a customer. In one embodiment, the method includes: (1) gaining access to call details for a call regarding the customer, (2) employing customer information and the call details to generate a CDR, (3) attaching a notation to the CDR, and (4) compiling at least one CDR in generating the billing data.

Yet another aspect provides an automatic billing communication system. In one embodiment, the system includes: (1) a voice communication device configured to: (1a) carry out calls, thereby generating respective call details, (1b) prompt for and accept respective notations for the calls, (1c) generate respective CDRs based on the respective call details and the respective notations, and (1d) associate the respective CDRs with respective customers, (2) a remote database configured to store customer information, the CDRs and billing data for the respective customers, and (3) a portal operable to gain access to the remote database for managing the customer information and capturing the billing data.

Yet another aspect provides a call notation system, including: (1) a database configured to store a CDR including call details retrieved from a voice communication subsystem and a notation associated with a call, and (2) an application operable to interact with the voice communication subsystem to retrieve the call details and configured to accept the notation and generate the CDR.

### BRIEF DESCRIPTION

Reference is now made to the following descriptions taken in conjunction with the accompanying drawings, in which:

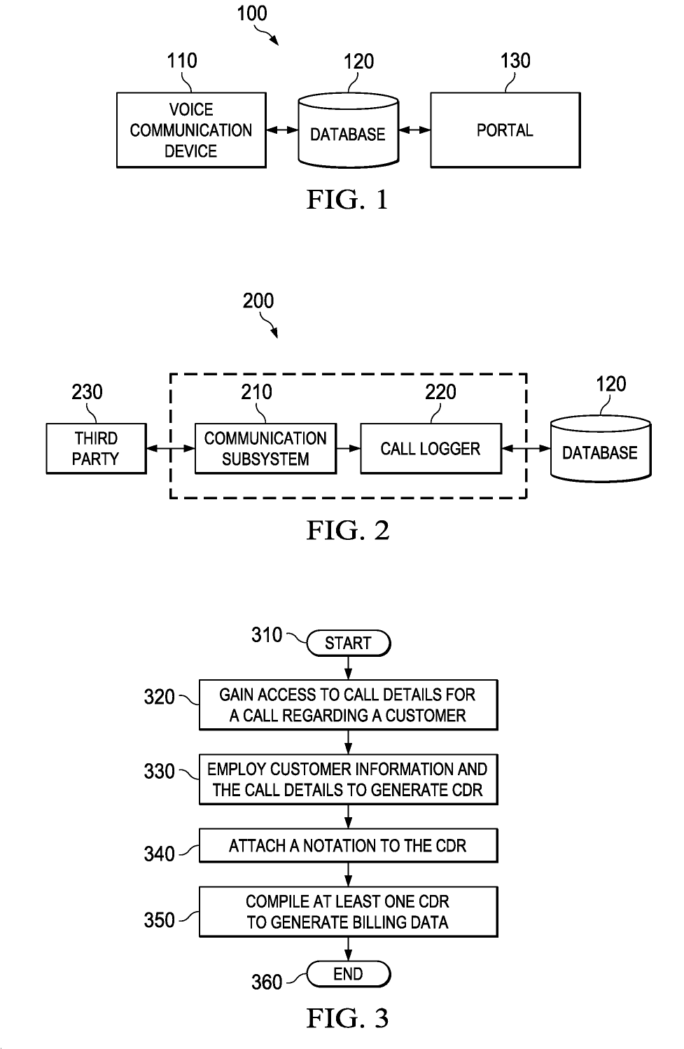

FIG. 1 is a block diagram of one embodiment of an automatic billing communication system;

FIG. 2 is a block diagram of one embodiment of a notation-enabled communication device; and

FIG. 3 is a flow diagram of one embodiment of a method for generating billing data for a customer.

### DETAILED DESCRIPTION

Among time-tracking solutions are those directed to capturing time spent on telephone calls. Telephone calls frequently fall outside available timekeeping methods, because they are carried out on distinct devices. Many time-tracking solutions are not integrated with office telephone systems, or are not compatible with certain cell telephones. Cross platform solutions have been developed to expand timekeeping capability to virtually every desktop telephone, or “land line,” and to a wide variety of smart telephones running a variety of operating systems. Call tracking systems allow the gathering of call details that can be used to generate invoices. Professionals and administrators can then compile data for multiple calls to generate billing data. Call details helpful in this regard include call duration and client association. Additionally, some call tracking systems accept a designation of a billing status for the call, which allows professionals to filter out billable calls from non-billable.

It is realized herein that call tracking systems tend to gather insufficient information. More specifically, the information call tracking systems gather is sometimes inadequate to reconcile a call with a customer, and the time spent in the call is ultimately lost. In other circumstances, the context of the call or the impressions of the professional may be lost, resulting in additional time spent recovering that information. It is realized herein that these shortcomings can be overcome by accepting notations that can be associated with and attached to call detail records (CDRs) that are otherwise created by a call tracking system. It is further realized herein that these notations can be made in the form of text, audio or a combination of text and audio. Likewise, it is also realized herein that these notations can be stored as text, audio or a combination of text and audio. It is realized herein that a call tracking system integrated into the voice communication device can accept or even prompt a user to add a notation to the CDR. The user can then record a voice memo, type a text note, or make any other notation that can be recorded and attached to the CDR. The CDR can then be submitted to a database for storage along with customer information and ultimately billing data.

Access to the CDR and any attached notations can be had by professionals and administrators to use the information to generate billing data, invoices and reports, among other things. Data in the CDRs can be supplemented with customer information also available in the database to aid in the generation of billing data. Users may wish to access notations directly from the database, or the notations can be exported to additional systems for dissemination.

FIG. 1 is a block diagram of one embodiment of an automatic billing communication system 100 within which the notation-enabled communication device or method of generating customer billing data introduced herein may be embodied or carried out. Communication system 100 includes a voice communication device 110, a database 120 and a portal 130.

Voice communication device 110 is a device capable of transmitting and receiving voice communication. Voice communication includes inbound and outbound calls. Voice communication devices include operating system (OS) based voice systems such as land line telephones, desktop telephones, mobile telephones, smart telephones and voice over internet protocol (VOIP) telephones. Voice communication devices may also include personal computers (PCs) or tablet computers capable of voice communication, typically through voice communication software. In certain embodiments, voice communication device 110 executes an application for accepting notations that interacts with the voice communication system's OS.

Upon termination of a call with a third party, voice communication device 110 retrieves call details sufficient to generate a call detail record (CDR). Call details include the date and time of the call, duration, customer, timekeeper, billing status and others. In certain embodiments, voice communication device 110 prompts the user to select the billing status for the call. The user may choose to classify the call as billable or non-billable. In some circumstances, such as a personal call, the user may choose to make calls to that third party never billable. In other circumstances, the billing status may be unknown. Occasionally, calls are made between the user and a third party that is not a customer, but the call pertains to a customer. In those circumstances, voice communication device 110 allows the user to classify a call as billable. Voice communication device 110 also accepts or, in certain embodiments, prompts the user to add a notation to the CDR. Notations include text and audio notations, such as a voice memo.

In alternate embodiments, voice communication device 110 gains access to customer information to aid in the determination of a billing status or to supplement the CDR. Customer information includes contact information, attorney information, locations, departments, matter numbers, billing rates and billing codes. Customer information may be stored locally on the voice communication device or remotely, on a server or “cloud” in the form of a customer information file (CIF). In either case, CIFs are stored in a database, such as database 120.

In other embodiments, a non-OS based voice communication device 110 is made notation-enabled by connecting it to a server or “backbone” capable of gathering call details and accepting notations for generating CDRs.

Database 120 is primarily a storage system configured to store customer information via CIFs and CDRs. Additionally, database 120 can store applications that can be downloaded to voice communication device 110 for managing the customer information and call details. Database 120 is also configured to store timekeeping records generated from the CIFs and CDRs. Timekeeping records are part of the billing data necessary to generate a bill for a customer. Database 120 can be a locally stored database, residing on voice communication device 110, or remote, stored on a server or cloud. Voice communication device 110 gains access to database 120 to retrieve customer information and to submit CDRs for storage. Voice communication device 110 may utilize a variety of communication methods to gain access to database 120 depending on a given system's architecture. In certain embodiments, voice communication device 110 communicates with database 120 over a network connection using a communication protocol such as WiFi, IP or Ethernet, among others. Other embodiments may employ the communication channel over which voice communication is carried out, such as a twisted pair telephone line. Alternate embodiments may employ some form of a data bus, such as a serial channel or parallel interface.

Portal 130 grants users access to database 120 through a PC or mobile computing device. Certain embodiments employ a thin client, such as a web browser, to address and interact with database 120 over a network connection. Portal 130 may also be a terminal local to database 120. Portal 130 allows a user to view, add, edit and delete CIFs and to enter customer information into database 120. Similarly, portal 130 can also be used to manage CDRs on database 120. Managing CDRs includes editing, sorting, exporting, archiving, deleting, viewing CDRs and viewing logs and reports based on CDRs.

FIG. 2 is a block diagram of one embodiment of a notation-enabled communication device 200. Communication device 200 includes a communication subsystem 210 and a call logger 220. Call logger 220 is configured to interface with a database, such as database 120 of FIG. 1. Communication subsystem 210 is configured to carry out voice communication with a third party 230 and is the underlying voice communication system for communication device 200. Third party 230 may receive or originate a call with communication subsystem 210 over a voice communication channel. Voice communication channels include VOIP, cellular, traditional twisted pair or “land line,” and others. Third party 230 may or may not be a customer.

Call logger 220 gains access to call associated with a call carried out by communication subsystem 210. Call logger 220 may supplement the call details with customer information stored in database 120 to form a CDR. Call logger 220 also accepts a designation of a billing status for the call, which may be billable, non-billable, never billable, unknown or others. Upon termination of the call, call logger 220 accepts notations from a user to be attached to the CDR. In certain embodiments, the user is prompted at the end of a call to enter a notation. In other embodiments, the user initiates a procedure by which a notation is attached. Notations can be text, audio or a combination of text and audio. Notations are attached to the CDR and are submitted by call logger 220 to be stored in database 120. For example, at the end of a call a user can record a voice memo summarizing the content of the call. Call logger 220 would attach the voice memo as an audio notation in the CDR that can be recalled and used for generating billing data.

FIG. 3 is a flow diagram of one embodiment of a method for generating billing data for a customer. The method begins in a start step 310. In a step 320, access is gained to call details for a call regarding a customer. Call details include date and time of a call, duration of a call, the customer to which the call pertains, designation of a timekeeper, a billing status and others. Billing status is an indicator of whether time spent on the call is billable, non-billable, never billable, or whether the billing status is simply unknown or not determined. In a step 330, a CDR is generated based on the call details from step 320 and customer information. Customer information includes customer contact information, billing rates, billing codes, attorney information, customer locations, customer departments and other data. In certain embodiments, customer information is stored in a customer information file (CIF). CIFs are either stored locally on the communication device or remotely on a server. CIFs are created independent of calls and can be managed through a portal.

A notation is attached to the CDR at step 340. Once a call is complete, the user may choose to create a notation or note to explain or comment about some aspect of the call. Notations may be text, voice or a combination of text and voice. The notation is attached to the CDR. In certain embodiments, CDRs are submitted to a remote database for storage. Later, all CDRs pertaining to a given customer or matter may be recalled through the database. In a step 350, one or more CDRs are compiled to generate billing data for the customer. In alternate embodiments, reports are generated containing billing data for one or more customers for review. In other embodiments, a user can gain access to CDRs to supplement or modify the data within. The method then ends in a step 360.

Those skilled in the art to which this application relates will appreciate that other and further additions, deletions, substitutions and modifications may be made to the described embodiments.

1. A notation-enabled communication device, comprising:
a communication subsystem operable to transmit and receive communication data associated with a call; and
a call logger configured to accept notations associated with said call, generate a call detail record (CDR) based on said call and said notations and submit said CDR to a database without user intervention.

2. The notation-enabled communication device recited in claim 1 wherein said communication subsystem is a cellular communication system.

3. The notation-enabled communication device recited in claim 1 wherein said database is configured to store customer information, billing records and CDRs.

4. The notation-enabled communication device recited in claim 3 wherein said call logger is operable to gain access to said customer information for use in generating said CDR.

5. The notation-enabled communication device recited in claim 1 wherein said call logger is further configured to prompt a user for a billable status for said call that is employed in generating said CDR.

6. The notation-enabled communication device recited in claim 1 wherein said notations are audio notations.

7. The notation-enabled communication device recited in claim 1 wherein said CDR includes the duration of said call and associates said call with a customer.

8. A method of generating billing data for a customer, comprising:
gaining access to call details for a call regarding said customer;
employing customer information and said call details to generate a call detail record (CDR);
attaching a notation to said CDR; and
compiling at least one CDR in generating said billing data,
wherein said gaining access, employing and compiling are performed without user intervention.

9. The method recited in claim 8 further comprising submitting said CDR to a remote database.

10. The method recited in claim 9 wherein said compiling includes gaining access to a plurality of CDRs and said customer information.

11. The method recited in claim 8 further comprising determining a billing status for said call.

12. The method recited in claim 8 wherein said attaching includes attaching a text notation to said CDR.

13. The method recited in claim 8 further comprising creating a customer information file (CIF) configured to store said customer information and associating said CIF with said CDR.

14. The method recited in claim 8 further comprising gaining access to said billing data through a data portal.

15. An automatic billing communication system, comprising:
a voice communication device configured to:
carry out calls, thereby generating respective call details,
prompt for and accept respective notations for said calls,
generate respective call detail records (CDRs) based on said respective call details and said respective notations, and
associate said respective CDRs with respective customers,
wherein said generating and associating by said voice communication device is performed without user intervention;
a remote database configured to store customer information, said CDRs and billing data for said respective customers; and
a portal operable to gain access to said remote database for managing said customer information and capturing said billing data.

16. The automatic billing communication system recited in claim 15 wherein said respective call details include:
date and time of a call,
duration of a call,
billable status of a call, and
customer identification for a call.

17. The automatic billing communication system recited in claim 15 wherein said voice communication device is a mobile telephone.

18. The automatic billing communication system recited in claim 15 wherein said voice communication device is a desktop landline telephone.

19. The automatic billing communication system recited in claim 15 wherein said portal is a thin-client configured to gain access to said remote database via the internet.

20. The automatic billing communication system recited in claim 15 wherein each of said respective notations are accepted in a form selected from the group consisting of:
an audio notation;
a text notation; and
a combination voice and text notation.

21. A call notation system, comprising:
a database configured to store a call detail record (CDR) including call details retrieved from a voice communication subsystem and a notation associated with a call; and
an application operable to interact with said voice communication subsystem to retrieve said call details and configured to accept said notation and generate said CDR without user intervention.

22. The call notation system recited in claim 21 wherein said application is executable by an operating system (OS) based voice communication device.

23. The call notation system recited in claim 22 wherein said application is configured to be executed by a smart phone.

24. The call notation system recited in claim 21 further comprising a portal through which said database is accessible.

25. The call notation system recited in claim 21 wherein said database is further configured to store customer information associated with said call.
